(19) United States
(12) Patent Application Publication
(10) Pub. No.: US 2023/0394375 A1
(43) Pub. Date: Dec. 7, 2023

(54) PROACTIVE IDENTIFICATION AND REMEDIATION FOR IMPACTED EQUIPMENT COMPONENTS USING MACHINE LEARNING

(71) Applicant: Dell Products L.P., Round Rock, TX (US)

(72) Inventors: Parminder Singh Sethi, Ludhiana (IN); Lakshmi Saroja Nalam, Bangalore (IN); Ramya G A, Bangalore (IN)

(21) Appl. No.: 17/834,621

(22) Filed: Jun. 7, 2022

(51) Int. Cl. G06N 20/20

(52) U.S. Cl. CPC G06N 20/20

(57) ABSTRACT

Techniques are disclosed for equipment support management comprising proactive identification and remediation for one or more impacted components of the equipment using a machine learning-based approach. By way of one example, a method identifies, for given equipment comprising a plurality of components, one or more components of the plurality of components that may be impacted by another component of the plurality of components for which an issue has been reported, wherein one or more machine learning-based algorithms are used to perform at least a portion of the identification. The method then generates, for the given equipment, a plan to proactively remedy the one or more identified components in conjunction with remedying the issue-reported component. In some further examples, a relevance tree is used to identify the one or more impacted components.

### FIELD

The field relates generally to information processing systems, and more particularly to machine learning-based processing in such information processing systems.

### BACKGROUND

Typically, when a product sold by a product manufacturing entity malfunctions or does not otherwise perform as expected and is under a warranty policy, the customer can have it replaced or repaired according to the warranty policy. For example, assume a customer purchases a piece of computing equipment, e.g., a laptop, a server, a storage system, etc., from an original manufacturing entity (OEM). The customer would typically receive OEM support to deal with any technical issues that occur with the computing equipment. The OEM support team would analyze the issue reported by the customer with respect to the computing equipment, initiate repair or replacement of the computing equipment, and thus resolve the technical issue.

In the case where the computing equipment is replaced for the customer, the original computing equipment can be repaired and resold to another customer who is made fully aware that the computing equipment is refurbished. However, there may be scenarios where the refurbished product is resold to another customer and one or more new technical issues arise that the OEM support team has to address. Such a recurring cycle of support team involvement on the same piece of equipment can have a significant adverse impact on the OEM, not to mention the inconvenience to the customers themselves.

### SUMMARY

Illustrative embodiments provide techniques for equipment support management comprising proactive identification and remediation for one or more impacted components of the equipment using a machine learning-based approach.

For example, in an illustrative embodiment, a method comprises the following steps performed by a processing platform comprising at least one processor coupled to at least one memory configured to execute program code. The method comprises identifying, for given equipment comprising a plurality of components, one or more components of the plurality of components that may be impacted by another component of the plurality of components for which an issue has been reported, wherein one or more machine learning-based algorithms are used to perform at least a portion of the identification. The method then generates, for the given equipment, a plan to proactively remedy the one or more identified components in conjunction with remedying the issue-reported component.

Advantageously, in one or more illustrative embodiments, identification of the one or more impacted components further comprises constructing a relevance data structure wherein nodes of the data structure represent at least a portion of the plurality of components of the given equipment in an order comprising a component most impacted by the issue-reported component to a component least impacted by the issue-reported component. Further, the remedial plan may advantageously be completed prior to a resale or a redeployment of the given equipment.

These and other illustrative embodiments include, without limitation, apparatus, systems, methods and computer program products comprising processor-readable storage media.

### BRIEF DESCRIPTION OF THE DRAWINGS

FIG. 1 illustrates an information processing system environment configured with machine learning-based equipment support management functionalities comprising a relevance tree processing engine according to an illustrative embodiment.

FIG. 2 illustrates a workflow associated with a relevance tree processing engine according to an illustrative embodiment.

FIG. 3 illustrates a relevance tree model used by a relevance tree processing engine according to an illustrative embodiment.

FIG. 4 illustrates a relevance tree generated by a relevance tree processing engine according to an illustrative embodiment.

FIGS. 5-7 tabularly illustrate an exemplary use case for a workflow associated with a relevance tree processing engine according to an illustrative embodiment.

FIGS. 8-11 illustrate exemplary decision trees used in a workflow associated with a relevance tree processing engine according to an illustrative embodiment.

FIGS. 12-14 further tabularly illustrate an exemplary use case for a workflow associated with a relevance tree processing engine according to an illustrative embodiment.

FIG. 15 illustrates a methodology for machine learning-based equipment support management according to an illustrative embodiment.

FIG. 16 illustrates an example of a processing platform utilized to implement at least a portion of an information processing system for machine learning-based equipment support management according to an illustrative embodiment.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as illustratively used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments.

Some cloud infrastructures are within the exclusive control and management of a given enterprise, and therefore are considered “private clouds.” On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure.

The term “enterprise” as illustratively used herein is intended to be broadly construed, and may comprise, for example, one or more businesses, one or more corporations, or any other one or more entities, groups, or organizations. An “entity” as illustratively used herein may be a person or system.

Numerous other types of enterprise computing and storage systems are also encompassed by the term “information processing system” as that term is broadly used herein. As illustratively used herein, the terms “client,” “customer” or “user” are intended to be broadly construed so as to encompass numerous arrangements of human, hardware, software or firmware entities, as well as combinations of such entities.

As mentioned, there may be scenarios where a refurbished product (more generally, equipment) is resold to another customer (e.g., different than the previous customer) and a technical issue arises that an OEM support team has to address. As illustratively used herein, the term “equipment” is intended to refer to any item that is composed of a plurality of components that operate to perform some functionality. While a laptop is used herein as an example of equipment with which machine learning-based equipment support management techniques according to illustrative embodiments are implemented, it is to be appreciated that alternative embodiments are not limited to this type of equipment but are more generally applicable to a wide variety of other equipment types.

By way of example only, assume a laptop is returned to an OEM because of a malfunctioning fan, which thereby causes a dispatch request to be generated. The laptop can be repaired by the OEM by replacing the fan. While the original customer might get a new replacement laptop, the original laptop with the replaced fan can be resold as a refurbished laptop to another customer. However, assume that the original customer used the laptop for several days/weeks with the malfunctioning fan. Unknown to the OEM, this might have damaged other components such as the processor, hard disk drive, etc. Now, the OEM may receive a new dispatch request when one or more of these other components exhibit technical issues and require repair or replacement.

Thus, when an issue is reported with a component in given equipment, other components may also be affected. However, since the issue is reported only on one component, the OEM support team will not be aware of the other components and a remedy will only be provided to address the issue of the reported component. This results in the return and repair or replacement of the same equipment multiple times which can result in significant cost to the OEM, as well as inconvenience to the customers.

To avoid this recurring return/repair/replace scenario, before reselling equipment refurbished with a repaired or replaced component A, it is realized herein that it would be advantageous to identify other components (B, C, D, etc.) in the equipment that may be affected by the previous technical issue suffered by component A, confirm that there are no technical issues that occurred with respect to these other components, and remedy any issues if they did occur before providing the refurbished equipment for resale or redeployment.

Illustrative embodiments provide automated, machine learning-based equipment support management techniques for proactively identifying and taking proactive remedial action to fix one or more components in equipment that is the subject of repair/replacement with respect to another component. More particularly, illustrative embodiments proactively identify any components affected (referred to herein as “impacted components”) by an issue-reported component in given equipment and proactively address any potential and/or actual issues with respect to such impacted components to avoid or at least minimize multiple dispatch requests for the same equipment.

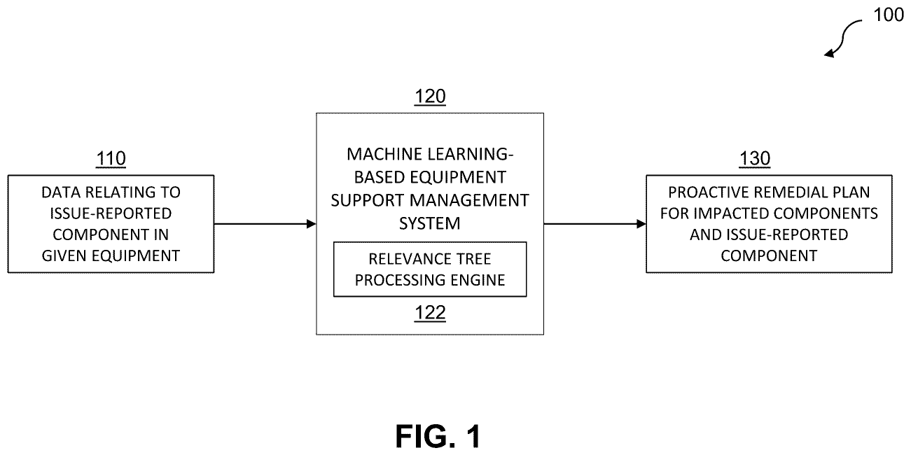

Referring initially to FIG. 1, an information processing system environment 100 is shown configured with machine learning-based equipment support management functionalities according to an illustrative embodiment. More particularly, data 110 related to an issue-reported component in given equipment is input to a machine learning-based equipment support management system 120 configured with a relevance tree processing engine 122. As will be explained in further detail herein, relevance tree processing engine 122 is configured to proactively identify and create a plan to take remedial action to repair/replace any impacted components in the given equipment in conjunction with the issue-reported component, i.e., proactive remedial plan 130. In this manner, relevance tree processing engine 122 identifies any component or components affected due to the issue-reported component and proactively addresses their issues to avoid or minimize future dispatch requests.

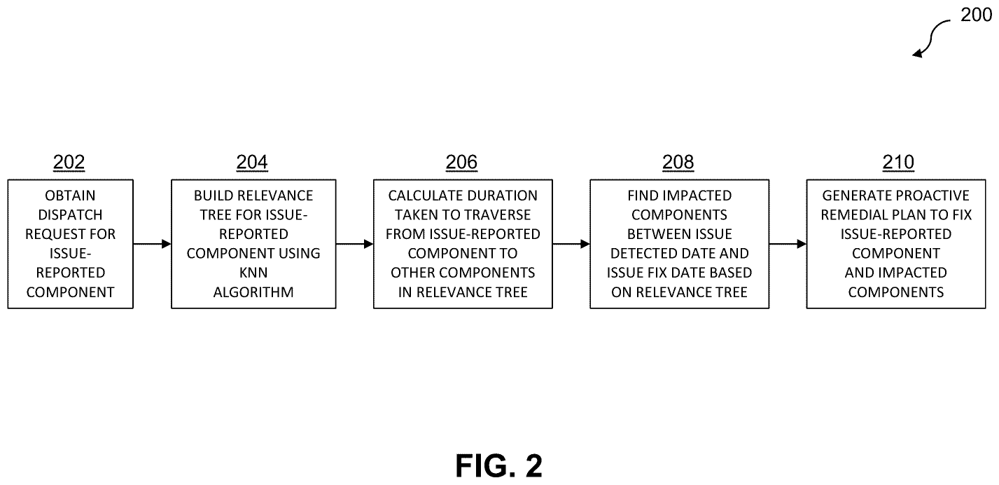

FIG. 2 illustrates a workflow 200 executable by relevance tree processing engine 122 according to an illustrative embodiment. As shown in workflow 200, step 202 obtains a dispatch request for an issue-reported component in a given piece of equipment. As mentioned, a dispatch request corresponds to a customer request for repair or replacement of a product that the customer purchased from an OEM or other supplier. The repair or replacement service may be under a warranty policy. The obtained dispatch request is a data file that describes the technical issue(s) that the customer is experiencing and also typically identifies at least one component (issue-reported component) of the product that is not working properly, e.g., a malfunctioning fan in a laptop.

Step 204 builds a data structure in the form of a relevance tree for the issue-reported component using a k-nearest neighbor (KNN) algorithm as will be further described in detail herein. Then, step 206 calculates an attribute for the relevance tree representing a duration taken to traverse from the issue-reported component to other components in the relevance tree. Step 208 then finds impacted components between an issue detected date (IDD) and an issue fix date (IFD) based on the relevance tree, as will be explained. Step 210 generates a proactive remedial action plan to fix (repair or replace) the issue-reported component and any components likely to have been impacted during the time period defined by the IDD and IFD.

More particularly, in one or more illustrative embodiments, a relevance tree is a data structure built to determine the order/priority of the impacted components. The relevance tree starts with the most relevant component and ends with the least relevant component. Illustrative embodiments build the relevance tree to determine the order of the impacted components due to the issue detected in a component using the k-nearest neighbors (KNN) algorithm. KNN algorithm is a classification algorithm in machine learning and belongs to the supervised learning domain. Further, the KNN algorithm is referred to as being non-parametric since it does not make any underlying assumptions about the distribution of data. For the KNN algorithm, the value of k is specified by the user. Hamming distance is used to calculate the distance for categorical variables. If the value (x) and the value (y) are the same, the distance D will be equal to 0; otherwise, D=1:

$${D}_{H} = {\sum }_{i = 1}^{k} \vert {x}_{i} - {y}_{i} \vert$$

$$x = y ⟹ D = 0$$

$$x \neq y ⟹ D = 1$$

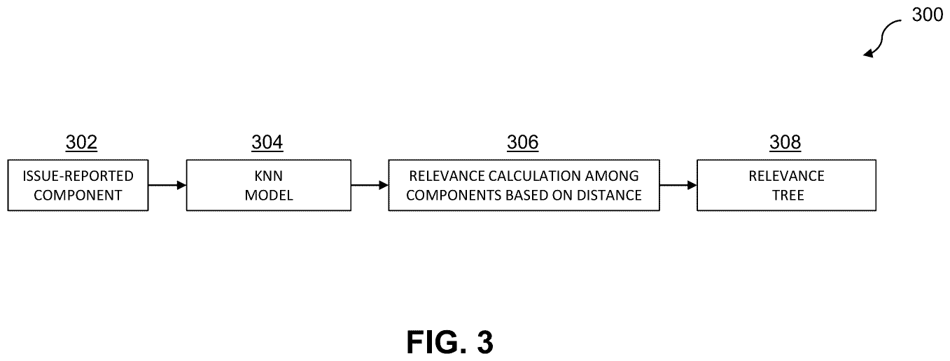

Thus, in one or more illustrative embodiments, the KNN algorithm is applied to the equipment support management use case for a given piece of equipment as shown in a relevance tree model 300 of FIG. 3. As depicted in FIG. 3, an issue-reported component 302 is input to a KNN model 304. A relevance calculation 306 is performed between the issue-reported component 302 and other components in the given equipment based on the Hamming distance equation above. A relevance tree 308 is then constructed based on the relevance calculations.

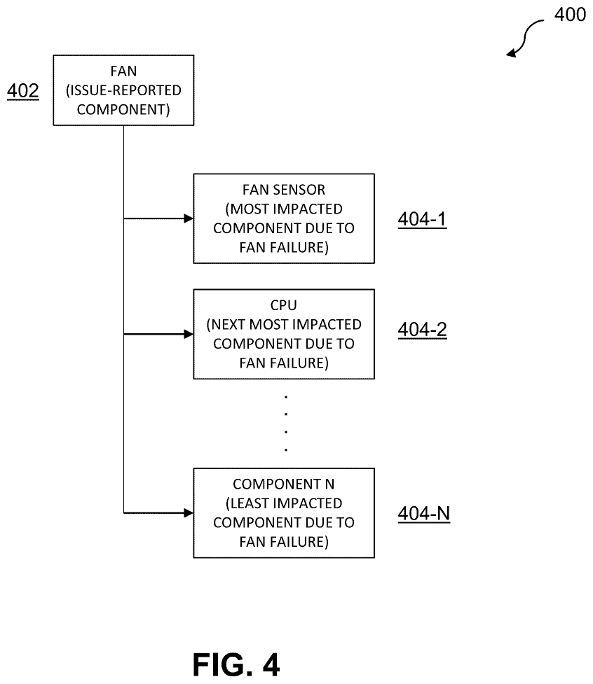

FIG. 4 illustrates a relevance tree 400 generated in accordance with workflow 200 of FIG. 2 and relevance tree model 300 of FIG. 3. As shown, assume fan 402 is the issue-reported component, i.e., the malfunctioning (e.g., failed) component in the laptop that is the subject of a dispatch request initiated by a customer. Then, as shown, assume that the most impacted component due to a fan failure in the laptop is a fan sensor 404-1, followed by the laptop processor or CPU 404-2. Component 404-N at the bottom of relevance tree 400 represents the component that is least impacted by a fan failure.

Once relevance tree 400 is built, recall from step 206 of FIG. 2 that duration attributes are calculated as the time taken to traverse from the current state of relevance tree 400 to the next state of relevance tree 400, i.e., from a fan failure state to a failure state of the next most likely component to fail due to the fan failure, e.g., a CPU failure state. For example, based on support information such as support tickets and logs for the issue-reported component (e.g., accessible by relevance tree processing engine 122 from one or more equipment support management databases maintained by the OEM), step 206 determines the duration between the current state and the next state. Using this support information, workflow 200 trains a model using a gradient boosting algorithm. Gradient boosting is a machine learning technique used in regression and classification tasks which generates a prediction model in the form of an ensemble of weaker prediction models, which are typically in the form of decision trees. Once trained, workflow 200 uses the same for predictions whenever a new dataset is available. Gradient boosting can be used for predicting not only a continuous target variable (as a regressor) but also a categorical target variable (as a classifier). In a gradient boosting regressor algorithm, the cost function is an MSE (mean square error) and the prediction model is an ensemble of decision trees. More particularly, in gradient boosting regression, each predictor corrects the error of its predecessor.

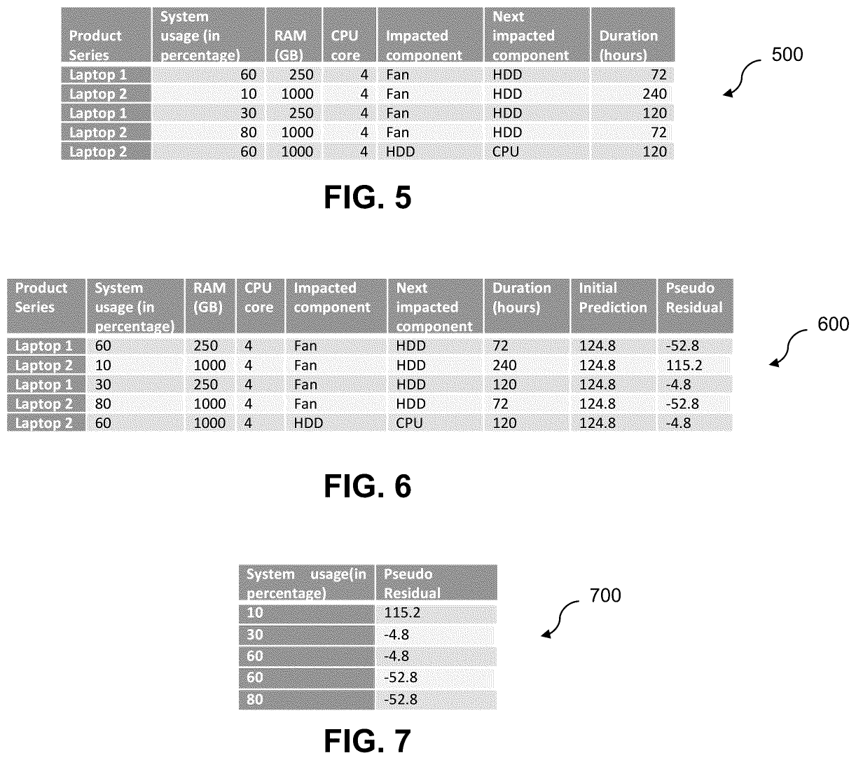

FIGS. 5-7 tabularly depict an example for training a model with a gradient boosting algorithm. Assume here that the target variable is the above-mentioned duration. Duration is shown in the last column of table 500 of FIG. 5. The initial prediction is calculated by taking the average duration for all the records (a row in table 500 is considered a record for a respective laptop). For example, the average value of duration is: (72+240+120+72+120)/5=124.8. As shown in the second to last column in table 600 of FIG. 6, this value is set as the initial prediction. The errors are then calculated based on the initial prediction as: pseudo residual=(observed duration−predicted duration). For example, the pseudo residual of the first record (first row of table 600) is calculated as 72−124.8=−52.8. Once the pseudo residual is calculated, a regression tree is built to train the model to determine the duration for test data. To start, the root node of the regression tree is determined. To calculate the root node, the minimum sum of squared residuals (SSR) among all features associated with a laptop (i.e., system usage, RAM, etc.) is calculated. Table 700 of FIG. 7 is an example for calculating the SSR of the system usage feature (in percentage).

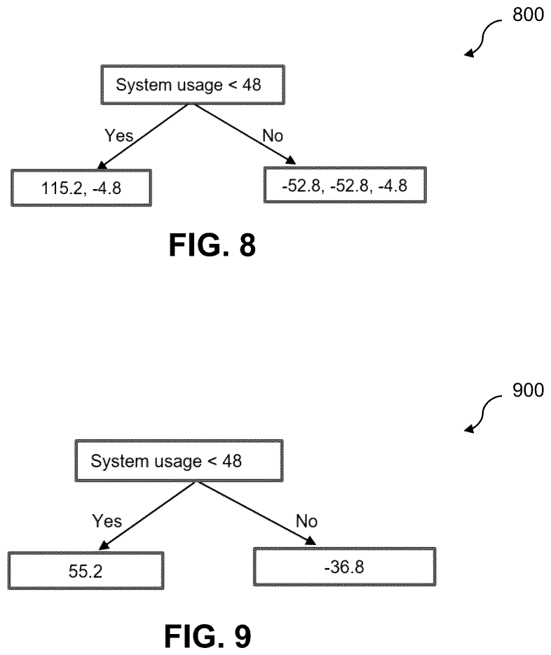

Further, the average system usage is calculated as: (10+30+60+60+80)/5=48. Based on table 700, a decision tree 800 as shown in FIG. 8 is generated as part of the gradient boosting algorithm. The average value of the left leaf node is: (115.2+(−4.8))/2=55.2, while the average value of the right leaf node is: (−52.8+(−52.8)+(−4.8))/2=−36.8. Decision tree 900 as shown in FIG. 9 depicts the system usage feature based on these calculated values.

The algorithm now calculates the sum of squared residuals (SSR) as the square of (observed value−predicted value). For the left leaf node in decision tree 800, there are only two records:
1^{st} record: (115.2−55.2)²=3600
2^{nd} record: (−4.8−55.2)²=3600
   Therefore, the SSD of the left leaf node is: (3600+3600)=7200.

Similarly, the SSD is calculated for all the records of the right leaf node of decision tree 800, i.e., the SSD of the right leaf node is: (256+256+1024)=1536.

Now, the algorithm adds the SSD of both left and right leaf nodes of the system usage tree to calculate a tree residual. Tree residual=SSD of left leaf node+SSD of right leaf node=7200+1536. As such, the tree residual of the system usage tree is 8736.

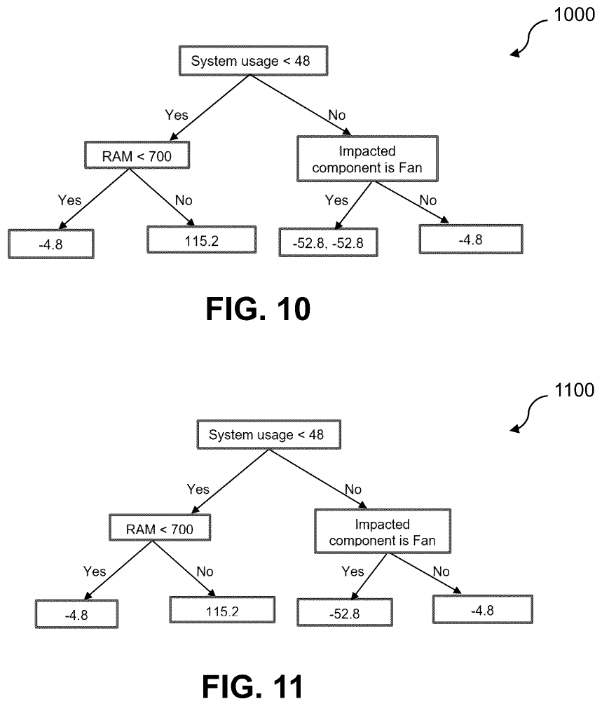

Similarly, the tree residual is calculated for all other features such as RAM, CPU core, impacted component, etc. Once completed, the tree with the minimum tree residual is considered as the root node and a regression decision tree is built. FIG. 10 depicts a regression decision tree 1000 for this use case.

Since the left leaf node of the “impacted component is fan” node has two values, the average of the two values is taken, i.e., (−52.8+(−52.8))/2=−52.8. Thus, FIG. 11 depicts an updated regression decision tree 1100 using the average of the two values.

To make a new prediction of an individual duration from the training data, consider the 1st record, i.e., first row in table 600 of FIG. 6. The initial prediction plus the residual from the updated regression decision tree 1100 is: 124.8+(−52.8)=72. The model fits the training data too well, i.e., there is a low bias and a very high variance. Hence, a learning rate is used with a value between 0 and 1. In this case, assume the learning rate as 0.1. With this learning rate, the duration is calculated as: initial prediction+(learning rate * residual from tree), i.e.: 124.8+(0.1*(−52.8))=119.52.

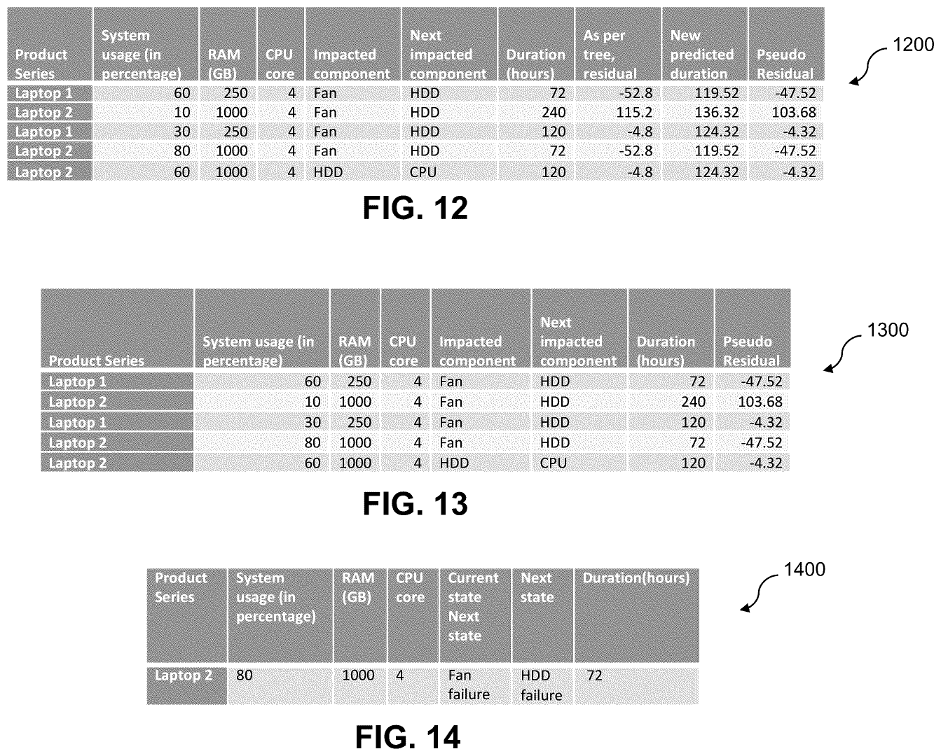

Similarly, the duration of other records is calculated with the learning rate. Scaling the tree by the learning rate results in a relatively small step in the correct direction. This results in better prediction which is a lower variance. Table 1200 of FIG. 12 depicts the new predicted duration (second to last column) based on the learning rate for all the records. Table 1300 of FIG. 13 then depicts the next tree built using this data. The formula to calculate the target variable (duration) is: average weight+learning rate * tree1+learning rate * tree2, . . . .

Each time a tree is added to the prediction, the residual gets smaller. Trees are added to the ensemble of trees until a maximum size is reached or until adding additional trees does not significantly reduce the residual.

Returning to FIG. 2, recall that step 208 finds the impacted components between the IDD and IFD based on relevance tree 400 of FIG. 4. Relevance tree facilitates determining the most impacted component (404-1) through the least impacted component (404-N) due to the issue-reported component (402). From step 206 (adding duration to the relevance tree as explained in detail above), the duration taken to traverse from one state to another state is determined. Based on the logs and data collected for the issue-reported component, the IDD is obtained. For example, assume the IDD is Jan. 24, 2022, the IFD is Jan. 31, 2022, and the issue-reported component is the fan with the issue being “fan failure.” The duration between the dates is (IFD−IDD)=7 days. With the current state as “fan failure” and with the other parameters of the tree (that can be determined using telemetry), the impacted components are predicted now so that remediation can be provided to the impacted components instead of just for the issue-reported component.

For example, assume the next impacted component in the laptop is the hard disk drive (HDD) with respect to the issue-reported component (fan). This is determined using the relevance tree. To find the duration attribute for this data, as per the tree, the duration is calculated. For this example, assume a duration of three days, i.e., 72 hours, as illustrated in table 1400 of FIG. 14. With the assistance of the duration added in the relevance tree and the IDD, the subset of the impacted components can be determined until the IFD. Since the duration for the fix is seven days, workflow 200 of FIG. 2 finds the impacted components for the next four days. The relevance tree and the gradient boosting algorithm described in detail herein are used recursively to determine the subset of impacted components so that a remedy can be provided for the impacted components.

That is, once the subset of impacted components is obtained from step 208, a remedial action plan is determined in step 210 enabling the OEM support team to address the technical issue of the component reported by the customer and the technical issues of the impacted components.

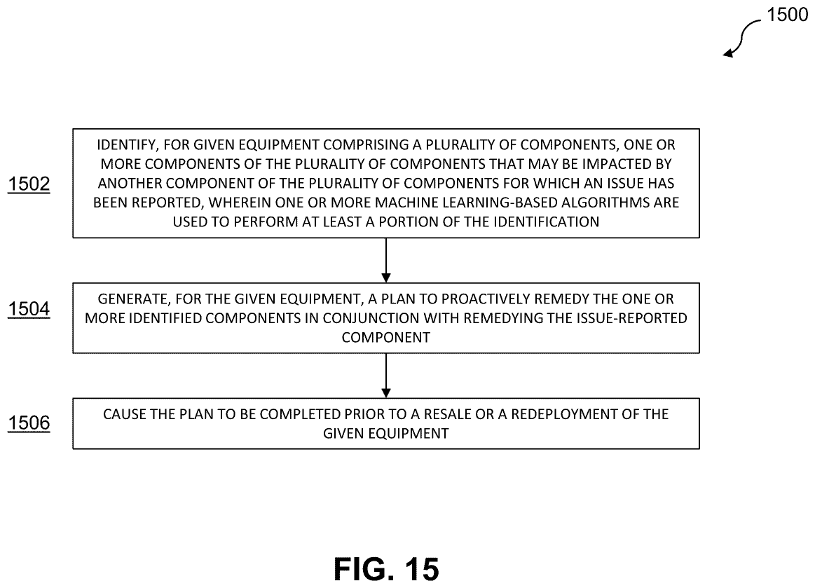

FIG. 15 illustrates a methodology 1500 for machine learning-based equipment support management according to an illustrative embodiment. It is to be understood that methodology 1500 can be implemented in relevance tree processing engine 122 of FIG. 1 in one or more illustrative embodiments.

As shown, step 1502 identifies, for given equipment comprising a plurality of components, one or more components of the plurality of components that may be impacted by another component of the plurality of components for which an issue has been reported, wherein one or more machine learning-based algorithms are used to perform at least a portion of the identification.

Step 1504 generates, for the given equipment, a plan to proactively remedy the one or more identified components in conjunction with remedying the issue-reported component.

Step 1506 causes the plan to be completed prior to a resale or a redeployment of the given equipment.

Advantageously, by way of example only, illustrative embodiments predict the list of the components that may show any type of after-effects of an issue reported on given equipment by computing a hamming distance. Further, illustrative embodiments compute the time it will take to show the after-effects of the reported issue by leveraging the state of the equipment, including healthy and unhealthy components, using gradient boosting. Still further, illustrative embodiments proactively identify and recommend the remedy for the after-effect on any components by building a relevance tree prior to the components showing the after-effects. Advantageously, this proactive approach results in fewer customer escalations, fewer replacements, and a better user experience.

Illustrative embodiments are described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Cloud infrastructure can include private clouds, public clouds, and/or combinations of private/public clouds (hybrid clouds).

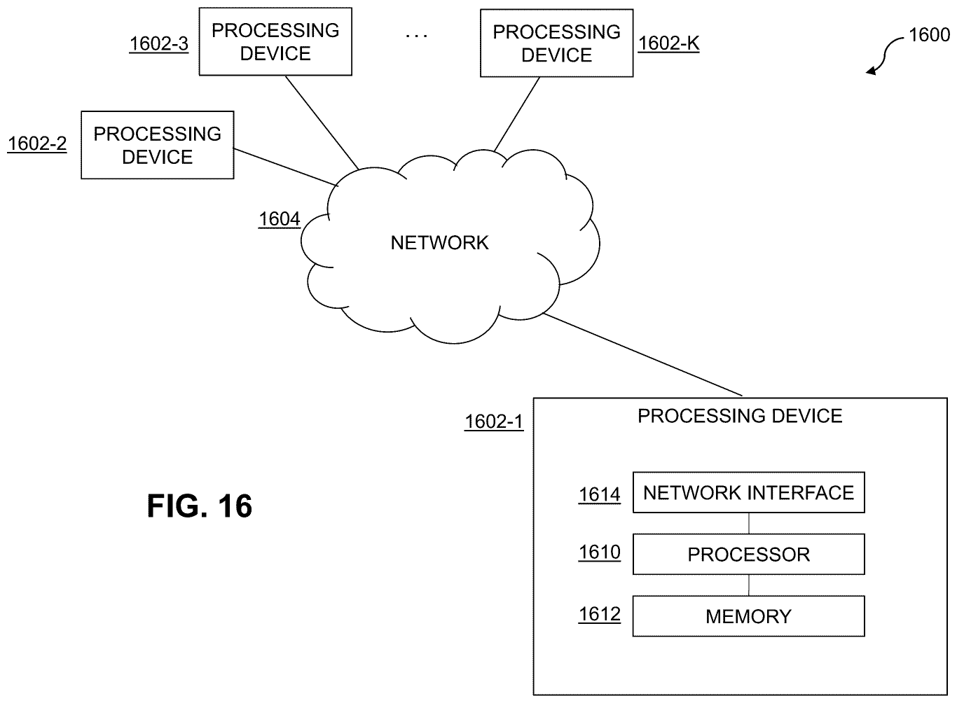

FIG. 16 depicts a processing platform 1600 used to implement information processing systems/processes depicted in FIGS. 1 through 15, respectively, according to an illustrative embodiment. More particularly, processing platform 1600 is a processing platform on which a computing environment with functionalities described herein can be implemented.

The processing platform 1600 in this embodiment comprises a plurality of processing devices, denoted 1602-1, 1602-2, 1602-3, . . . 1602-K, which communicate with one another over network(s) 1604. It is to be appreciated that the methodologies described herein may be executed in one such processing device 1602, or executed in a distributed manner across two or more such processing devices 1602. It is to be further appreciated that a server, a client device, a computing device or any other processing platform element may be viewed as an example of what is more generally referred to herein as a “processing device.” As illustrated in FIG. 16, such a device generally comprises at least one processor and an associated memory, and implements one or more functional modules for instantiating and/or controlling features of systems and methodologies described herein. Multiple elements or modules may be implemented by a single processing device in a given embodiment. Note that components described in the architectures depicted in the figures can comprise one or more of such processing devices 1602 shown in FIG. 16. The network(s) 1604 represent one or more communications networks that enable components to communicate and to transfer data therebetween, as well as to perform other functionalities described herein.

The processing device 1602-1 in the processing platform 1600 comprises a processor 1610 coupled to a memory 1612. The processor 1610 may comprise a microprocessor, a microcontroller, an application-specific integrated circuit (ASIC), a field programmable gate array (FPGA) or other type of processing circuitry, as well as portions or combinations of such circuitry elements. Components of systems as disclosed herein can be implemented at least in part in the form of one or more software programs stored in memory and executed by a processor of a processing device such as processor 1610. Memory 1612 (or other storage device) having such program code embodied therein is an example of what is more generally referred to herein as a processor-readable storage medium. Articles of manufacture comprising such computer-readable or processor-readable storage media are considered embodiments of the invention. A given such article of manufacture may comprise, for example, a storage device such as a storage disk, a storage array or an integrated circuit containing memory. The term “article of manufacture” as used herein should be understood to exclude transitory, propagating signals.

Furthermore, memory 1612 may comprise electronic memory such as random-access memory (RAM), read-only memory (ROM) or other types of memory, in any combination. The one or more software programs when executed by a processing device such as the processing device 1602-1 causes the device to perform functions associated with one or more of the components/steps of system/methodologies in FIGS. 1 through 15. One skilled in the art would be readily able to implement such software given the teachings provided herein. Other examples of processor-readable storage media embodying embodiments of the invention may include, for example, optical or magnetic disks.

Processing device 1602-1 also includes network interface circuitry 1614, which is used to interface the device with the networks 1604 and other system components. Such circuitry may comprise conventional transceivers of a type well known in the art.

The other processing devices 1602 (1602-2, 1602-3, . . . 1602-K) of the processing platform 1600 are assumed to be configured in a manner similar to that shown for computing device 1602-1 in the figure.

The processing platform 1600 shown in FIG. 16 may comprise additional known components such as batch processing systems, parallel processing systems, physical machines, virtual machines, virtual switches, storage volumes, etc. Again, the particular processing platform shown in this figure is presented by way of example only, and the system shown as 1600 in FIG. 16 may include additional or alternative processing platforms, as well as numerous distinct processing platforms in any combination.

Also, numerous other arrangements of servers, clients, computers, storage devices or other components are possible in processing platform 1600. Such components can communicate with other elements of the processing platform 1600 over any type of network, such as a wide area network (WAN), a local area network (LAN), a satellite network, a telephone or cable network, or various portions or combinations of these and other types of networks.

Furthermore, it is to be appreciated that the processing platform 1600 of FIG. 16 can comprise virtual (logical) processing elements implemented using a hypervisor. A hypervisor is an example of what is more generally referred to herein as “virtualization infrastructure.” The hypervisor runs on physical infrastructure. As such, the techniques illustratively described herein can be provided in accordance with one or more cloud services. The cloud services thus run on respective ones of the virtual machines under the control of the hypervisor. Processing platform 1600 may also include multiple hypervisors, each running on its own physical infrastructure. Portions of that physical infrastructure might be virtualized.

As is known, virtual machines are logical processing elements that may be instantiated on one or more physical processing elements (e.g., servers, computers, processing devices). That is, a “virtual machine” generally refers to a software implementation of a machine (i.e., a computer) that executes programs like a physical machine. Thus, different virtual machines can run different operating systems and multiple applications on the same physical computer. Virtualization is implemented by the hypervisor which is directly inserted on top of the computer hardware in order to allocate hardware resources of the physical computer dynamically and transparently. The hypervisor affords the ability for multiple operating systems to run concurrently on a single physical computer and share hardware resources with each other.

It was noted above that portions of the computing environment may be implemented using one or more processing platforms. A given such processing platform comprises at least one processing device comprising a processor coupled to a memory, and the processing device may be implemented at least in part utilizing one or more virtual machines, containers or other virtualization infrastructure. By way of example, such containers may be Docker containers or other types of containers.

The particular processing operations and other system functionality described in conjunction with FIGS. 1-16 are presented by way of illustrative example only, and should not be construed as limiting the scope of the disclosure in any way. Alternative embodiments can use other types of operations and protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should again be emphasized that the above-described embodiments of the invention are presented for purposes of illustration only. Many variations may be made in the particular arrangements shown. For example, although described in the context of particular system and device configurations, the techniques are applicable to a wide variety of other types of data processing systems, processing devices and distributed virtual infrastructure arrangements. In addition, any simplifying assumptions made above in the course of describing the illustrative embodiments should also be viewed as exemplary rather than as requirements or limitations of the invention.

What is claimed is:

1. An apparatus comprising:
a processing platform comprising at least one processor coupled to at least one memory, the processing platform, when executing program code, is configured to:
identify, for given equipment comprising a plurality of components, one or more components of the plurality of components that may be impacted by another component of the plurality of components for which an issue has been reported, wherein one or more machine learning-based algorithms are used to perform at least a portion of the identification; and
generate, for the given equipment, a plan to proactively remedy the one or more identified components in conjunction with remedying the issue-reported component.

2. The apparatus of claim 1, wherein identifying the one or more components that may be impacted further comprises constructing a relevance data structure wherein nodes of the data structure represent at least a portion of the plurality of components of the given equipment in an order comprising a component most impacted by the issue-reported component to a component least impacted by the issue-reported component.

3. The apparatus of claim 2, wherein the relevance data structure is constructed using a k-nearest neighbor algorithm.

4. The apparatus of claim 3, wherein the k-nearest neighbor algorithm comprises using a distance measure to determine the order of the plurality of components.

5. The apparatus of claim 2, wherein identifying the one or more components that may be impacted further comprises calculating a duration attribute for traversal between failure states of the components represented in the relevance data structure.

6. The apparatus of claim 5, wherein the duration attribute is predicted using a gradient boosting algorithm.

7. The apparatus of claim 6, wherein the duration attribute is calculated based on an initial prediction, an error value, and a learning rate.

8. The apparatus of claim 5, wherein identifying the one or more components that may be impacted further comprises utilizing the duration attribute in association with an issue detected date and an issue fix date for the issue-reported component to identify the one or more components that may be impacted.

9. The apparatus of claim 1, wherein the processing platform, when executing program code, is further configured to cause the plan to be completed prior to a resale or a redeployment of the given equipment.

10. A method comprising:
identifying, for given equipment comprising a plurality of components, one or more components of the plurality of components that may be impacted by another component of the plurality of components for which an issue has been reported, wherein one or more machine learning-based algorithms are used to perform at least a portion of the identification; and
generating, for the given equipment, a plan to proactively remedy the one or more identified components in conjunction with remedying the issue-reported component;
wherein the identifying and generating steps are performed by a processing platform comprising at least one processor coupled to at least one memory executing program code.

11. The method of claim 10, wherein identifying the one or more components that may be impacted further comprises constructing a relevance data structure wherein nodes of the data structure represent at least a portion of the plurality of components of the given equipment in an order comprising a component most impacted by the issue-reported component to a component least impacted by the issue-reported component.

12. The method of claim 11, wherein the relevance data structure is constructed using a k-nearest neighbor algorithm.

13. The method of claim 12, wherein the k-nearest neighbor algorithm comprises using a distance measure to determine the order of the plurality of components.

14. The method of claim 11, wherein identifying the one or more components that may be impacted further comprises calculating a duration attribute for traversal between failure states of the components represented in the relevance data structure.

15. The method of claim 14, wherein the duration attribute is predicted using a gradient boosting algorithm.

16. The method of claim 15, wherein the duration attribute is calculated based on an initial prediction, an error value, and a learning rate.

17. The method of claim 14, wherein identifying the one or more components that may be impacted further comprises utilizing the duration attribute in association with an issue detected date and an issue fix date for the issue-reported component to identify the one or more components that may be impacted.

18. The method of claim 10, further comprising causing the plan to be completed prior to a resale or a redeployment of the given equipment.

19. A computer program product comprising a non-transitory processor-readable storage medium having stored therein program code of one or more software programs, wherein the program code when executed by at least one processing device cause the at least one processing device to:
identify, for given equipment comprising a plurality of components, one or more components of the plurality of components that may be impacted by another component of the plurality of components for which an issue has been reported, wherein one or more machine learning-based algorithms are used to perform at least a portion of the identification; and
generate, for the given equipment, a plan to proactively remedy the one or more identified components in conjunction with remedying the issue-reported component.

20. The computer program product of claim 19, wherein identifying the one or more components that may be impacted further comprises constructing a relevance data structure wherein nodes of the data structure represent at least a portion of the plurality of components of the given equipment in an order comprising a component most impacted by the issue-reported component to a component least impacted by the issue-reported component.
